(19) United States
(12) Patent Application Publication
(10) Pub. No.: US 2013/0265967 A1
(43) Pub. Date: Oct. 10, 2013

(54) METHOD FOR RESOURCE ALLOCATION AND DEVICE

(71) Applicant: Huawei Technologies Co, Ltd., Shenzhen (CN)

(72) Inventor: Minqi Zhang, Shanghai (CN)

(21) Appl. No.: 13/908,777

(22) Filed: Jun. 3, 2013

Related U.S. Application Data
(63) Continuation of application No. PCT/CN2011/081889, filed on Nov. 8, 2011.

(30) Foreign Application Priority Data
Dec. 24, 2010 (CN) 201010606831.5

(51) Int. Cl. H04W 28/06

(52) U.S. Cl. CPC H04W 28/06
USPC 370/329

(57) ABSTRACT

A method for resource allocation and a device are disclosed by the present disclosure, relating to the field of communications technologies, and used for increasing the utilization rate of air interface resources. The method for resource allocation according to embodiments of the present disclosure includes: calculating a mean value of lengths of at least two compressed packets, where the compressed packets are obtained by performing header compression on original packets; and allocating resources according to the mean value of the lengths of the at least two compressed packets. The solutions provided in the embodiments of the present disclosure are applicable to the allocation of air interface resources during resource allocation.

### CROSS-REFERENCE TO RELATED APPLICATIONS

This application is a continuation of International Application No. PCT/CN2011/081889, filed on Nov. 8, 2011, which claims priority to Chinese Patent Application No. 201010606831.5, filed on Dec. 24, 2010, both of which are hereby incorporated by reference in their entireties.

### TECHNICAL FIELD

The present disclosure relates to the field of communications technologies and, in particular, to a method for resource allocation and a device.

### BACKGROUND

In LTE (Long Term Evolution) systems, a resource allocation method with semi-persistent scheduling is applicable to services when a size of packets is relatively fixed and the arrival time interval of packets meets a certain rule.

Taking a VoIP (Voice over IP) service as an example, when the arrival period of VoIP packets is 20 ms, a base station or a terminal sends a VoIP packet or receives a newly arrived VoIP packet every 20 ms in the same resource position. In the VoIP service, the base station may allocate resources in advance, where a size of allocated resources includes a size of resources occupied by an original VoIP packet, a Packet Data Convergence Protocol (PDCP, Packet Data Convergence Protocol) layer protocol header, a Radio Link Control (RLC, Radio Link Control Protocol) layer protocol header, and a Media Access Control (MAC, Media Access Control) layer protocol header. The allocated resources are used periodically.

In the prior art, regardless of whether the packet undergoes header compression (ROHC, Robust Header Compression), the base station allocates resources for semi-persistent scheduling according to a length of the original packet, which causes waste of resources.

### SUMMARY

In one aspect, the present disclosure provides a method for resource allocation. The method includes calculating a mean value of lengths of at least two compressed packets, where the compressed packets are obtained by performing header compression on original packets, and allocating resources according to the mean value.

In another aspect, the present disclosure provides a device. The device includes a calculating unit configured to calculate a mean value of lengths of at least two compressed packets, where the compressed packets are obtained by performing header compression on original packets, and an allocating unit configured to allocate resources according to the mean value.

The method for resource allocation and the device according to the embodiments of the present disclosure, in cases where compressed packets are obtained by performing header compression on original packets, can allocate resources according to a mean value of lengths of the compressed packets. This reduces waste of air interface resources during resource allocation and increasing utilization rate of air interface resources.

### BRIEF DESCRIPTION OF THE DRAWINGS

For a more complete understanding of the present disclosure, and the advantages thereof, reference is now made to the following descriptions taken in conjunction with the accompanying drawing, in which:

FIG. 1 is a flowchart of a method for resource allocation according to an embodiment of the present disclosure;

FIG. 2 is a schematic diagram of a header compression operation;

FIG. 3 is a schematic diagram of a header compression operation in a VoIP service;

FIG. 4 is a schematic diagram of a device according to another embodiment of the present disclosure;

FIG. 5 is a schematic diagram of a calculating unit;

FIG. 6 is a schematic diagram of another calculating unit; and

FIG. 7 is a schematic diagram of an allocating unit.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present disclosure provides many applicable inventive concepts that can be embodied in a wide variety of specific contexts. The specific embodiments discussed are merely illustrative, and do not limit the scope of the disclosure.

The embodiments of the present disclosure are applicable to multiple communication systems including LTE systems and LTE Advance systems. The base station described in the embodiments may be an evolved base station or other devices for allocating resources for UEs.

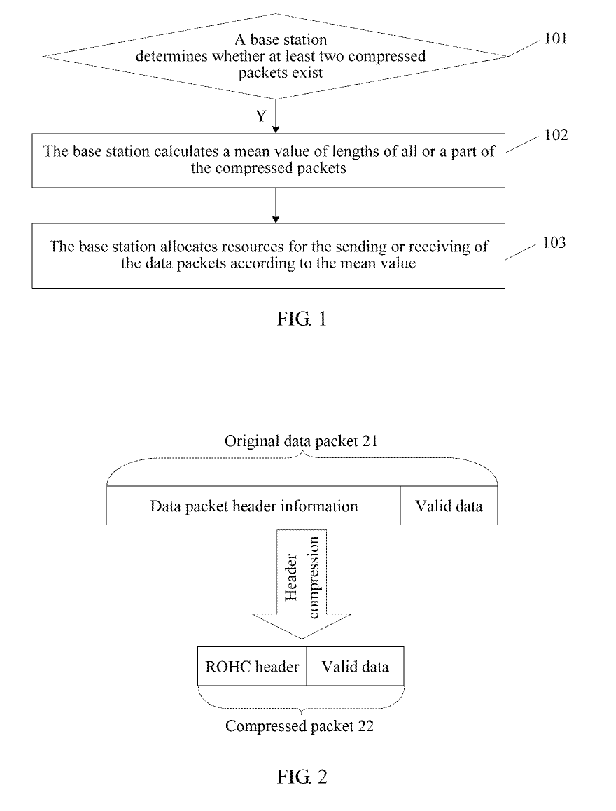

An embodiment of the present disclosure provides a method for resource allocation. As shown in FIG. 1, this embodiment includes the following steps:

101. A base station determines whether at least two compressed packets exist, where the compressed packets are obtained by performing header compression on original packets. If yes, step 102 is executed.

The header compression in this embodiment means compression of header information in a packet. As shown in FIG. 2, an original packet 21 is a packet without header compression and includes payload and packet header information. A compressed packet 22 is a packet obtained after header compression is performed on the original packet and includes the payload and a ROHC header, which is obtained after the packet header information in the original packet 21 is compressed. Because a length of the ROHC header is smaller than a length of the packet header information, a length of the compressed packet 22 is smaller than a length of the original packet 21.

In this step, the base station may determine whether the length of the packet is smaller than a preset threshold and, if so, determine that the packet is a compressed packet.

102. The base station calculates a mean value of lengths of all or a part of the compressed packets.

It is assumed that in step 101, the base station determines that 10 compressed packets exist. That is, ten (10) original packets undergo header compression.

Optionally, the base station calculates a mean value of the lengths of the 10 compressed packets or calculates a mean value of the lengths of n compressed packets therein, where n is a positive integer smaller than 10 and the n compressed packets may be selected from the 10 compressed packets randomly or in any other way.

Optionally, the base station calculates a mean value of compression rates of the lengths of the 10 compressed packets or calculates a mean value of compression rates of the lengths of n compressed packets therein, where n is a positive integer smaller than 10 and the n compressed packets may be selected from the 10 compressed packets randomly or in any other way. The compression rate here may be a ratio of the compressed packet 22 to the original packet 21. Then, the base station calculates a product of the mean value of the compression rates and a length of the original packet corresponding to the compressed packet used to calculate the mean value of the compression rates, so as to obtain the mean value of the lengths of the compressed packets. Alternatively, the compression rate here may be a ratio of the length of the ROHC header in the compressed packet 22 to the length of the packet header information in the original packet 21. Then, the base station calculates a product of the mean value of the compression rates and the length of the packet header information in the original packet corresponding to a compressed packet used to calculate the mean value of the compression rates, and adds the length of the payload in the compressed packet, so as to obtain the mean value of the lengths of the compressed packets.

For example, the lengths of the original packets corresponding to the 10 compressed packets are the same and the lengths of packet header information in the original packets are the same. Then the mean value of the lengths of the compressed packets determined by the base station in the above two ways is the same.

103. The base station allocates resources for the sending or receiving of the packets according to the mean value.

In this step, the base station may allocate resources according to the mean value and the lengths of other protocol layer headers. For example, the allocated resources are a sum of the mean value, the length of a Packet Data Convergence Protocol (PDCP) layer header, the length of a Radio Link Control (RLC) layer header, and the length of a Media Access Control (MAC) layer header. For another example, the allocated resources are slightly greater than the sum of the mean value, the length of a PDCP layer header, the length of an RLC layer header, and the length of a MAC layer header. Being slightly greater may be construed as that the allocated resources, though greater than the sum of the mean value and the lengths of the layer headers, are still fewer than the resources allocated based on the mean value of the original packets and the lengths of other protocol layer headers. For example, the mean value is multiplied by an amplification rate X, provided that the value of X makes the allocated resources fewer than the resources allocated based on the mean value of the original packets and the lengths of other protocol layer headers.

In this embodiment, because the length of a compressed packet is smaller than that of the original packet, determining allocated resources according to the length of the compressed packets can reduce waste of air interface resources and thereby increase utilization rate of air interface resources.

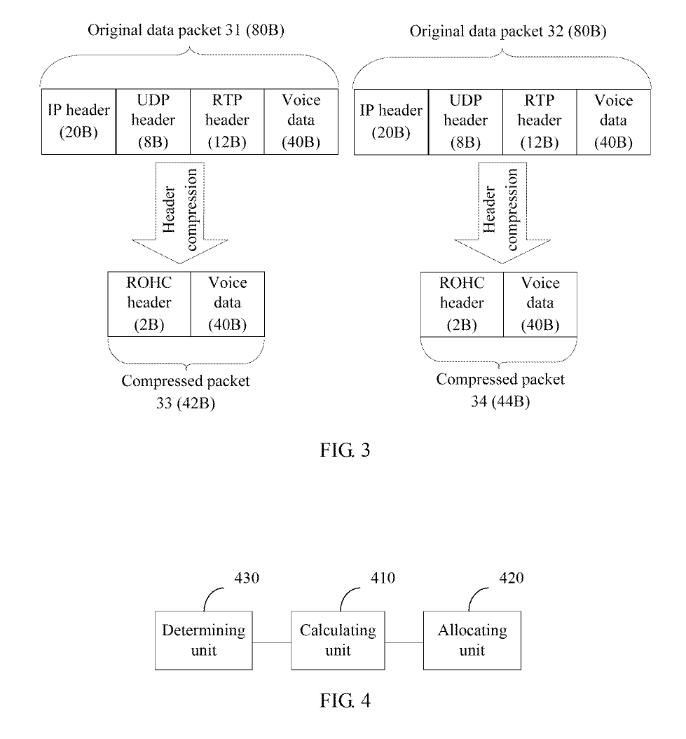

Another embodiment of the present disclosure describes how resources are allocated according to lengths of compressed packets by taking a VoIP service as an example. As shown in FIG. 3, lengths of two original VoIP packets 31 and 32 are both 80 bytes, where a length of payload of each original VoIP packet and a length of packet header information each are 40 bytes. For example, IP (Internet Protocol) header information in the packet header information is 20 bytes, a UDP (User Datagram Protocol) header information is 8 bytes, and an RTP (Real-time Transport Protocol) header information is 12 bytes. A length of a compressed packet 33 obtained by performing header compression on the original VoIP packet 31 is 42 bytes, where a length of the payload is 40 bytes and the ROHC header is 2 bytes. A length of the compressed packet 34 obtained by performing header compression on the original VoIP packet 32 is 44 bytes, where a length of the payload is 40 bytes and the ROHC header is 40 bytes.

Optionally, assuming that a preset threshold is 50 bytes, the base station determines that the packet 33 and the packet 34 are compressed packets and calculates their mean value as 43 bytes. Assuming that a length of the PDCP layer header, a length of the RLC layer header, and a length of the MAC layer header are respectively 2 bytes, 3 bytes, and 2 bytes, resources that may be allocated by the base station for the compressed packet 33 and the compressed packet 34 are 50 bytes.

Optionally, a compression rate of a compressed packet may be a ratio of the length of the compressed packet to the length of the original packet. In this case, the compression rate of the packet 33 obtained by the base station according to the lengths of the packet 33 and the original packet 31 is 52.5% and the compression rate of the packet 34 obtained according to the ratio of the length of the packet 34 to the corresponding original length is 55%. Both are lower than 100%. Then, the base station determines that the packet 33 and the packet 34 are both compressed packets and calculates a mean value of the compression rates of the two packets as 53.75%, and then multiplies the mean value of the compression rates by 80 bytes (the length of the original packet 31 or original packet 32) to obtain a mean value of the lengths of the compressed packet 33 and the compressed packet 34 as 43 bytes. Assuming that a length of the PDCP layer header, a length of the RLC layer header, and a length of the MAC layer header are respectively 2 bytes, 3 bytes, and 2 bytes, resources that may be allocated by the base station for the compressed packet 33 and the compressed packet 34 are 50 bytes.

Optionally, a compression rate of a compressed packet may be a ratio of the length of the ROHC header in the compressed packet to a sum of lengths of headers (such as the IP header, the UDP header, and the RTP header) of an original packet. In this case, the compression rate of the packet 33 obtained by the base station is 5% and the compression rate of the packet 34 is 10%. Assuming that a threshold of the compression rate is 20%, the base station determines that both the packet 33 and the packet 34 are compressed packets and calculates a mean value of the compression rates corresponding to the two packets as 7.5%. The base station multiplies the mean value of the compression rates by 40 bytes (a sum of lengths of headers in the original packet 31 or a sum of lengths of headers in the original packet 32) to obtain a mean value of the lengths of the ROHC headers of the compressed packet 33 and the compressed packet 34 as 3 bytes. Then the base station adds 40 bytes (length of voice data in the compressed packet 33 or the compressed packet 34) to obtain the mean value of the lengths of the compressed packet 33 and the compressed packet 34 as 43 bytes. Assuming that a length of the PDCP layer header, a length of the RLC layer header, and a length of the MAC layer header are respectively 2 bytes, 3 bytes, and 2 bytes, resources that may be allocated by the base station for the compressed packet 33 and the compressed packet 34 are 50 bytes.

Optionally, in this embodiment, after the base station determines the mean value of the lengths of the packets, the base station may multiply the mean value by an amplification rate and allocate resources according to the result obtained by multiplying the mean value by the amplification rate. If the amplification rate is higher, the value obtained by multiplying the mean value of the lengths of the compressed packets by the amplification rate is closer to the lengths of the original packets, which guarantees that more packets are transmitted successfully, and the communication quality of UEs is better. If the amplification rate is lower, or even 100%, that is, the mean value of the lengths of the compressed packets is not amplified, air interface resources are saved more effectively. In practical applications, the amplification rate may be set according to a specific need. For example, the amplification rate may be 120%. Assuming that the mean value of the lengths of the compressed packets is 43 bytes, the mean value multiplied by the amplification rate 120% is 51.6 bytes. The base station may use the smallest positive integer that is greater than or equal to 51.6 bytes (which is 52 bytes) as a basis for resource allocation. For example, the base station adds the lengths of the PDCP layer header, the RLC layer header, and the MAC layer header to the smallest positive integer (52 bytes) and knows that the minimum resources to be allocated are 59 bytes.

The embodiment of the present disclosure is applicable to scenarios where a base station allocates resources for the transmission (for example, sending or receiving) of packets, and also applicable to scenarios where the base station adjusts allocated resources. The embodiment of the present disclosure is also applicable to a test stage and a stable stage during the transmission process of packets. The stage from the time when the base station (for example, as a packet sender) and the terminal (for example, as a packet receiver) start communication to the time when the communication is stable is called the test stage. The stage from the time when the communication is stable to the time when the communication ends is called the stable stage. The stable state is a state in which the length of transmitted packets remains unchanged or basically unchanged. Multiple methods may be used to determine whether the communication is stable. For example, the difference between the length of a packet and the length of a previous packet or the ratio of the length of a packet to the length of a previous packet is described as a fluctuation value of the packet. If fluctuation values of the lengths of M (M≧2) successive packets are smaller than a preset threshold, for example, 1%, it is considered that the communication enters the stable state, that is, the test stage ends and the stable stage begins.

In another embodiment of the present disclosure, a base station and a terminal communicate by using a semi-persistent scheduling service and compressed packets. The base station, as the packet sender, may calculate the mean value of lengths of all or a part of the compressed packets in the test stage and determine, according to the mean value, the resources for semi-persistent scheduling allocated in the stable stage. That is, the base station adjusts a size of the resources for semi-persistent scheduling allocated in the test stage or a time period therein to a size of the resources determined according to the mean value of the lengths.

By using the method for resource allocation according to the foregoing embodiments, the mean value of lengths of at least two compressed packets is calculated and resources are allocated according to the mean value. Because the mean value is smaller than the lengths of the original packets, using the method in the embodiments of the present disclosure in semi-persistent services can reduce the waste of air interface resources during resource allocation and thereby increase the utilization rate of air interface resources.

As shown in FIG. 4, another embodiment of the present disclosure provides a device, which may be used to implement the method provided in the foregoing embodiments. For example, the device is a base station, which may be used to implement the steps executed by a base station in the foregoing embodiments.

For example, the device provided in this embodiment includes: a calculating unit 410, configured to calculate a mean value of lengths of at least two compressed packets, where the compressed packets are obtained by performing header compression on original packets; and an allocating unit 420, configured to allocate resources according to the mean value.

Optionally, the device further includes a determining unit 430, configured to determine that at least two compressed packets exist.

Optionally, the determining unit 430 is specifically configured to determine whether at least two compressed packets exist. In an embodiment, the calculating unit 410 is specifically configured to calculate the mean value of lengths of all or a part of the existing compressed packets determined by the determining unit 430 when a determination result of the determining unit 430 is yes. In an embodiment, the allocating unit 420 is configured to allocate resources for the sending or receiving of the packets according to the mean value calculated by the calculating unit 410.

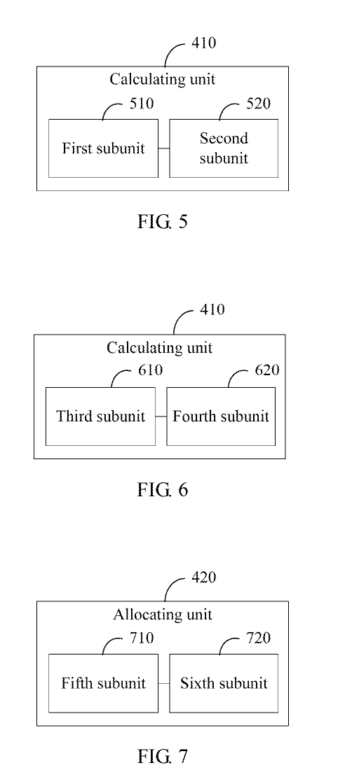

Optionally, as shown in FIG. 5, the calculating unit 410 includes a first subunit 510 and a second subunit 520. The first subunit 510 is configured to record compression rates of the at least two compressed packets, where the compression rate is a ratio of the length of a compressed packet to the length of an original packet. The second subunit 520 is configured to calculate a mean value of the compression rates of the at least two compressed packets recorded by the first subunit 510 and multiply the mean value of the compression rates of the at least two compressed packets by the lengths of the original packets of the at least two compressed packets to obtain the mean value of the lengths of the at least two compressed packets. For example, when the original packets of the compressed packets have the same length, for example, when the length of an original VoIP service packet is 80 bytes, the calculating unit 410 determines the mean value of the lengths of the at least two compressed packets by using the first subunit 510 and the second subunit 520.

Optionally, a compression rate of a compressed packet recorded by the first subunit 510 shown in FIG. 5 may also be a ratio of the length of the ROHC header in the compressed packet to the sum of lengths of headers in the original packet. In this case, the second subunit 520 is configured calculate the mean value of the compression rates of the at least two compressed packets recorded by the first subunit 510 and multiply the mean value of the compression rates by the length of packet header information in the original packet corresponding to one compressed packet to obtain the mean value of lengths of ROHC headers in the at least two compressed packets, and then add the length of payload in the compressed packet to obtain the mean value of the lengths of the at least two compressed packets. For example, when the original packets corresponding to the compressed packets have the same length and the lengths of packet header information in the original packets are also the same, for example, when the length of an original VoIP packet is 80 bytes, and the length of packet header information in the original packet is 40 bytes, the calculating unit 410 determines the mean value of the lengths of the at least two compressed packets by using the first subunit 510 and the second subunit 520.

Optionally, as shown in FIG. 6, the calculating unit 410 includes a third subunit 610 and a fourth subunit 620. The third subunit 610 is configured to record the lengths of the at least two compressed packets. The fourth subunit 620 is configured to calculate the mean value of the lengths of the at least two compressed packets. For example, when the original packets corresponding to the compressed packets have the same length or different lengths, the calculating unit 410 may determine the mean value of the lengths of the at least two compressed packets by using the third subunit 610 and the fourth subunit 620.

Optionally, as shown in FIG. 7, the allocating unit 420 includes a fifth subunit 710 and a sixth subunit 720. The fifth subunit 710 is configured to multiply the mean value calculated by the calculating unit 410, by an amplification rate, which may be 120%. The sixth subunit 720 is configured to allocate resources according to the mean value amplified by the fifth subunit 710. For example, when the allocating unit increases the set amplification rate, more compressed packets may be transmitted successfully. For another example, when the allocating unit reduces the set amplification rate, more resources may be saved.

The device provided in this embodiment can reduce the waste of air interface resources, and by adjusting the amplification rate, ensure the complete sending (or receiving) of more packets, thereby increasing the utilization rate of air interface resources.

From the above description of the embodiments, persons skilled in the art may clearly understand that the present disclosure may be implemented through software plus necessary universal hardware or implemented through hardware, where in many circumstances, the former is preferred. Based on such understanding, the technical solutions of the present disclosure in essence, or the parts contributing to the prior art, may be embodied in the form of a software product. The software product may be stored in a readable storage medium, such as a floppy disk, a hard disk, or a CD-ROM of a computer and include several instructions that enable a computer device (which may be a personal computer, a server, or a network device) to execute the method described in the embodiments of the present disclosure.

The foregoing descriptions are merely exemplary embodiments of the present disclosure, but not intended to limit the protection scope of the present disclosure. Any variation or replacement made by persons skilled in the art without departing from the technical scope of the embodiments of the present disclosure shall fall within the protection scope of the present disclosure. Therefore, the protection scope of the present disclosure shall be subject to the protection scope of the appended claims.

What is claimed is:

1. A method for resource allocation, comprising:
calculating a mean value of lengths of at least two compressed packets, wherein the compressed packets are obtained by performing header compression on original packets; and
allocating resources according to the mean value of the lengths of the at least two compressed packets.

2. The method according to claim 1, wherein before the calculating the mean value of the lengths of the at least two compressed packets, further comprising:
determining that the at least two compressed packets exist.

3. The method according to claim 1, wherein the calculating the mean value of the lengths of the at least two compressed packets comprises:
recording compression rates of the at least two compressed packets;
calculating a mean value of the compression rates of the at least two compressed packets; and
calculating the mean value of the lengths of the at least two compressed packets according to the mean value of the compression rates and a length of an original packet corresponding to one of the at least two compressed packets.

4. The method according to claim 3, wherein each of the compression rates is a ratio of a length of any one of the at least two compressed packets and a length of an original packet corresponding to the any one of the at least two compressed packets.

5. The method according to claim 4, wherein the any one of the at least two compressed packets is the same as or different from the one of the at least two compressed packets used to calculate the mean value of the lengths of the at least two compressed packets.

6. The method according to claim 1, wherein the calculating the mean value of the lengths of the at least two compressed packets comprises:
recording compression rates of the at least two compressed packets;
calculating a mean value of the compression rates of the at least two compressed packets; and
calculating the mean value of the lengths of the at least two compressed packets according to the mean value of the compression rates, a header in an original packet corresponding to one of the at least two compressed packets and a length of payload in the one of the at least two compressed packets.

7. The method according to claim 6, wherein each of the compression rates is a ratio of a length of a header in any one of the at least two compressed packets to a length of a header in an original packet corresponding to the any one of the at least two compressed packets.

8. The method according to claim 7, wherein the any one of the at least two compressed packets is the same as or different from the one of the at least two compressed packets used to calculate the mean value of the lengths of the at least two compressed packets.

9. The method according to claim 1, wherein the calculating the mean value of the lengths of the at least two compressed packets comprises:
recording the lengths of the at least two compressed packets; and
calculating the mean value of the lengths of the at least two compressed packets according to at least two of the recorded lengths of the at least two compressed packets.

10. The method according to claim 1, wherein the allocating resources according to the mean value of the lengths of the at least two compressed packets comprises:
multiplying the mean value of the lengths of the at least two compressed packets by an amplification rate; and
allocating resources according to the amplified mean value.

11. An apparatus, comprising:
a processor, configured to calculate a mean value of lengths of at least two compressed packets, wherein the compressed packets are obtained by performing header compression on original packets; and to allocate resources according to the mean value of the lengths of the at least two compressed packets.

12. The apparatus according to claim 11, the processor is further configured to determine that the at least two compressed packets exist before calculating the mea value of the lengths of the at least two compressed packets.

13. The apparatus according to claim 11, the processor is further configured to perform header compression on the original packets to obtain the compressed packets.

14. The apparatus according to claim 11, wherein the processor is configured to calculate a mean value of the compression rates of the at least two compressed packets; and to calculate the mean value of the lengths of the at least two compressed packets according to the mean value of the compression rates and a length of an original packet corresponding to one of the at least two compressed packets.

15. The apparatus according to claim 14, wherein the processor is further configured to calculate each of the compression rates, wherein the each of the compression rates is a ratio of a length of any one of the at least two compressed packets and a length of an original packet corresponding to the any one of the at least two compressed packets.

16. The apparatus according to claim 11, wherein the processor is configured to calculate a mean value of the compression rates of the at least two compressed packets; and to calculate the mean value of the lengths of the at least two compressed packets according to the mean value of the compression rates, a header in an original packet corresponding to one of the at least two compressed packets and a length of payload in the one of the at least two compressed packets.

17. The apparatus according to claim 16, wherein the processor is further configured to calculate each of the compression rates, wherein the each of the compression rates is a ratio of a length of a header in any one of the at least two compressed packets to a length of a header in an original packet corresponding to the any one of the at least two compressed packets.

18. The apparatus according to claim 11, wherein the processor is configured to calculate the mean value of the lengths of the at least two compressed packets according to at least two of the recorded lengths of the at least two compressed packets.

19. The apparatus according to claim 11, wherein the processor is further configured to multiply the mean value of the lengths of the at least two compressed packets by an amplification rate; and to allocate resources according to the mean value amplified by the processor.

20. The apparatus according to claim 11, further comprising: a memory, configured to record at least one of:
compression rates of the at least two compressed packets;
lengths of original packets corresponding to the at least two compressed packets;
lengths of the at least two compressed packets;
lengths of headers of original packets corresponding to the at least two compressed packets; and
lengths of headers of the at least two compressed packets.
